(19) United States
(12) Patent Application Publication
(10) Pub. No.: US 2012/0074893 A1
(43) Pub. Date: Mar. 29, 2012

(54) BATTERY CHARGING AND MANAGEMENT SYSTEMS AND RELATED METHODS

(75) Inventor: Christopher L. Cole, Cave Creek, AZ (US)

(73) Assignee: G2 LLC, Scottsdale, AZ (US)

(21) Appl. No.: 13/314,639

(22) Filed: Dec. 8, 2011

Related U.S. Application Data
(63) Continuation of application No. PCT/US2010/061899, filed on Dec. 22, 2010.
(60) Provisional application No. 61/289,333, filed on Dec. 22, 2009.

(51) Int. Cl. H01M 10/46

(52) U.S. Cl. 320/101

(57) ABSTRACT

Embodiments of battery charging systems are presented herein. Other examples and related methods are also presented herein.

### CROSS REFERENCE TO RELATED APPLICATION(S)

This patent application is a continuation to international PCT patent application No. PCT/US2010/061899, filed on Dec. 22, 2010, which claims priority to U.S. provisional patent application No. 61/289,333, filed on Dec. 22, 2009. The disclosures of the referenced applications above are incorporated herein by reference.

### TECHNICAL FIELD

This invention relates generally to renewable energy systems, and relates, more particularly, to battery charging and management systems and related methods.

### BACKGROUND

There are few necessities taken more for granted than electric power. And yet, in today's world, the vast majority of the energy generated for commercial and public use is derived by burning finite natural resources. Oil, coal, and gas dominate the world's energy consumption—accounting for more than two-thirds of global energy use—despite a continually dwindling supply. With fossil fuels warming the globe and conventional energy sources running out, true renewable solutions must be adopted as a base for a self-supporting future. Solar and wind power are two examples of renewable sources that are prime for exploitation and adoption.

The current systems for electrical power transmission rely on inefficient back and forth conversions between direct current (DC) and alternating current (AC) for transmission over power lines. To improve the efficiency of energy derived from renewable sources, renewable power may be generated on-site to reduce or eliminate the inefficiencies of the current transmission systems. Accordingly, a need exists to develop battery charging systems to efficiently generate power from such renewable sources on-site and to manage the storage of such generated power on corresponding batteries.

### BRIEF DESCRIPTION OF THE DRAWINGS

To facilitate further description of the embodiments, the following drawings are provided in which:

FIG. 1 illustrates a block diagram of a charging system comprising a charging station coupled to a power generator and to charger modules.

FIG. 2 illustrates a block diagram of the charging station of FIG. 1.

FIG. 3 illustrates a view of several receptacles of the charging station of FIGS. 1-2.

FIG. 4 illustrates a schematic view of an exemplary charger module of one or more charger modules for the charging station of FIGS. 1-2.

FIG. 5 illustrates a schematic of several configurations for different charger modules for the charging station of FIGS. 1-2.

FIG. 6 illustrates a side view of a battery charge coupler configured to couple a battery to a charge controller of the exemplary charger module of FIG. 4.

FIG. 7 illustrates a side view of the battery charge coupler of FIG. 6 configured to decouple the battery from the charge controller of the exemplary charger module of FIG. 4.

FIG. 8 illustrates a schematic of a remote charger port with exemplary wiring to couple a remote charging unit 1400 to the charging station of FIGS. 1-2.

FIG. 9 illustrates a scenario of how a remote charging unit may be installed remotely from the charging station of FIGS. 1-2 to support additional charger modules via remote receptacles.

FIG. 10 presents an optional power interface unit that may be coupled to the charging station and to the power generator of FIGS. 1-2.

FIG. 11 illustrates a sample graphical user interface (GUI) of a management application for the charging station of FIGS. 1-2, showing a “dashboard” display or system summary information for the charging system of FIG. 1.

FIG. 12 illustrates a schematic of a power management unit of the charging station of FIGS. 1-2.

FIG. 13 illustrates a view of a charging station in a power strip configuration.

FIG. 14 illustrates a flowchart of a method for providing a charging system like the charging system of FIG. 1.

FIG. 15 illustrates a flowchart of a method for using a charging system like the charging system of FIG. 1.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DESCRIPTION

In one embodiment, a system can comprise a charging station configured to control a charging of one or more rechargeable batteries, a power generator coupled to the charging station and configured to generate an input power, and a first charger module of one or more charger modules configured to couple to the charging station. The power generator can comprise a solar power generator configured to convert a solar energy to a solar DC power portion of the input power. The charging station can comprise a first system battery configured to collect a storage charge derived from the input power, one or more receptacles configured to couple the one or more charger modules to the charging station, and a system controller configured to control a concurrent transmission of an output power to each of the one or more receptacles based on charger module parameters of the one or more charger modules. The output power can be sourced from the storage charge of the first system battery. The first charger module can comprise a first battery charge controller set configured to individually and variably charge, with the output power received at a first receptacle of the one or more receptacles, one or more first batteries of a first battery set of the one or more rechargeable batteries. The first battery charge controller set can comprise a first battery charge controller, and the one or more first batteries can comprise a first battery. The first charger module can be configured to interchangeably couple to the charging station via the first receptacle, and couple the first battery charge controller set with the first battery set.

In a second embodiment, a method can comprise providing a charging station to control a charging of one or more rechargeable batteries, providing a power generator coupled to the charging station to generate an input power, and providing a first charger module of one or more charger modules to couple to the charging station a first battery set of the one or more rechargeable batteries. Providing the power generator can comprise providing a solar power generator to convert a solar energy to a solar power for the input power. Providing the charging station can comprise providing a first system battery to collect a storage charge derived from the input power, providing one or more receptacles configured to couple the one or more charger modules to the charging station, and providing a system controller to control an output power to each of the one or more receptacles based on charger module parameters received from the one or more charger modules. The output power can be sourced from the storage charge of the first system battery. Providing the first charger module can comprise configuring the first charger module to interchangeably couple to the charging station via a first receptacle selectable from the one or more receptacles, and providing a first battery charge controller set to couple with one or more batteries of the first battery set, to receive charging parameters from the system controller for each of the one or more batteries of the first battery set, and to variably charge each of the one or more batteries, based on the charging parameters from the system controller, with the output power received at the first receptacle. The charging parameters can be generated by the system controller based on the charger module parameters from the first charger module.

In a third embodiment, a method can comprise (a) providing a charging station, (b) coupling a solar power generator to the charging station, (c) collecting a storage charge at a system battery of the charging station, the storage charge derived from solar power received from the solar power generator, (d) coupling a first charger module of a plurality of charger modules to a first receptacle of one or more receptacles of the charging station, (e) coupling a first battery set to the first charger module, (f) receiving, at the charging station, charger module parameters from first charger module, the charger module parameters comprising at least two of a battery type of the first battery set, a battery quantity of the first battery set, a battery temperature of each battery of the first battery set, or a battery chemistry of each battery of the first battery set, and (g) receiving, at the first charger module, charging parameters from the charging station for each battery of the first battery set. The plurality of charger modules can be interchangeably connectable to the one or more receptacles for coupling to the charging station.

Other examples and embodiments are further disclosed herein. Such examples and embodiments may be found in the figures, in the claims, and/or in the description of the present application.

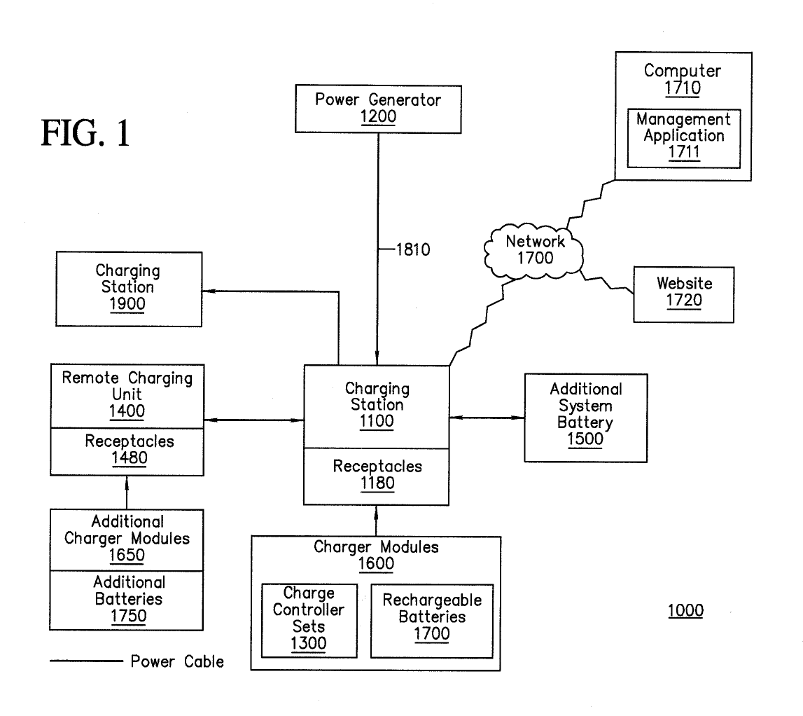

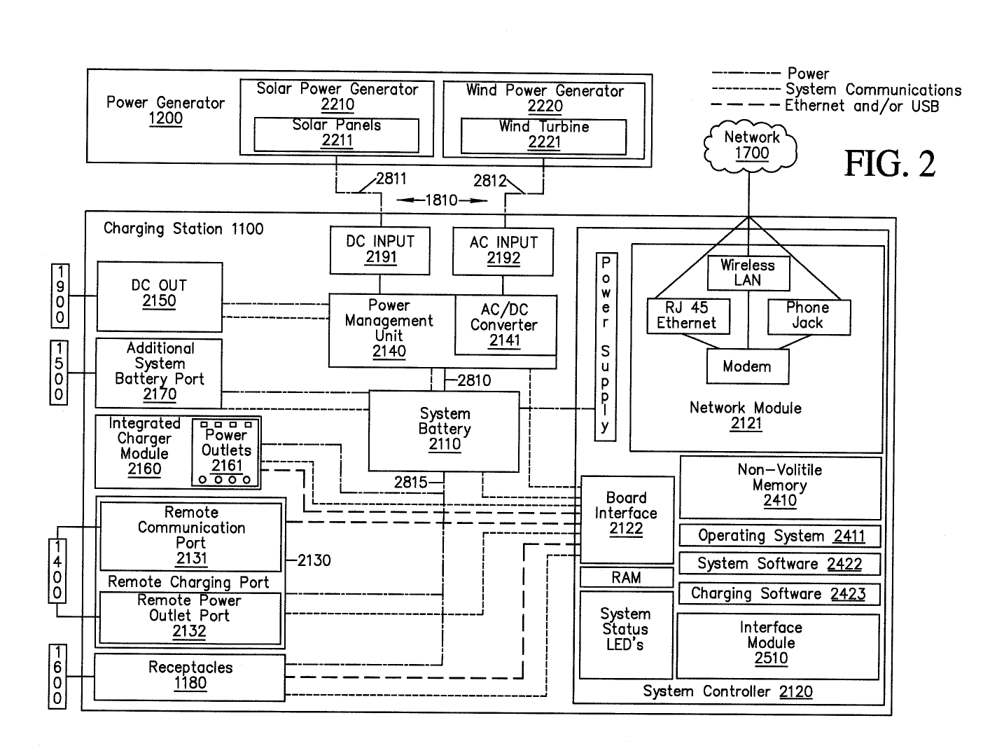

Turning now to the figures, FIG. 1 illustrates a block diagram of charging system 1000, comprising charging station 1100 coupled to power generator 1200 and to charger modules 1600. FIG. 2 illustrates a block diagram of charging station 1100. In the present example, charging station 1100 centrally controls charging system 1000, and is configured to control a charging of system battery 2110 and one or more rechargeable batteries coupled to charger modules 1600. In some examples charging station 1100 can be referred to as a main unit of charging system 1000.

Charging station 1100 is configured to receive input power 1810 at power management unit 2140 from power generator 1200, and to provide combined DC power 2810 to system battery 2110, where power management unit 2140 manages input power 1810 to derive combined DC power 2810. System battery 2110 is configured to collect storage charge from combined DC power 2810. In some examples, charging station 1100 may comprise additional system batteries similar to system battery 2110 to collect further storage charge from combined DC power 2810. Such additional system batteries may be internal to charging station 1100, like system battery 2110, or external, like additional system battery 1500. As seen in FIG. 2, additional system battery 1500 is coupled to charging station 1100 via additional system battery port 2170, and may be also charged or regulated by power management unit 2140. In the same or other examples, such additional system batteries like additional system battery 1500, whether internal or external, may be charged or regulated by power management unit 2140 as supplemental to system battery 2110.

Power generator 1200 is configured to generate input power 1810 for charging system 1000, where such input power 1810 may be derived from a variety of sources, such as solar energy or wind energy. As can be seen in FIG. 2, power generator 1200 can comprise solar power generator 2210 configured to receive sunlight via one or more solar panels 2211 to thereby convert solar energy into solar DC power 2811, where such solar DC Power 2811 can then be fed to charging station 1100 via DC input 2191 as a solar DC power portion of input power 1810.

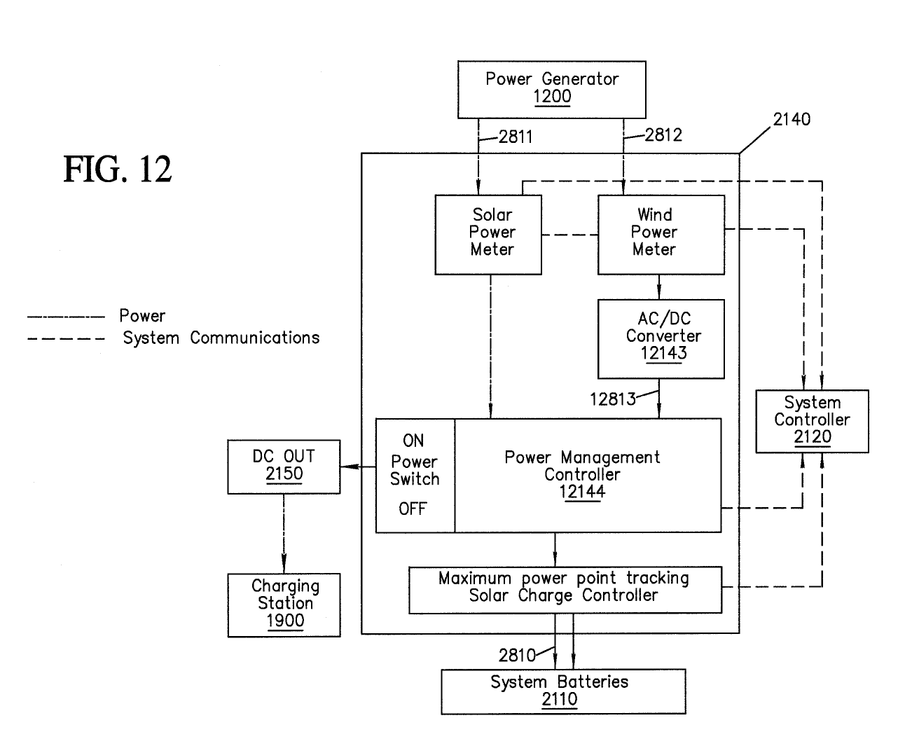

In the present example, power generator 1200 also comprises wind power generator 2220 to generate wind power from wind energy via one or more wind turbines 2221. The wind power will normally be wind AC power originally, and may be converted into wind DC power via an AC/DC converter. There can be examples where the AC/DC converter may be part of wind power generator 2220, and/or the wind AC power may be converted by the AC/DC converter to wind DC power prior to being sent to charging station 1100 as part of input power 1810. In the present example, however, charging station 1100 comprises power management unit 2140, and receives wind AC power 2812 at AC input 2192 from wind power generator 2220. FIG. 12 illustrates a schematic of power management unit 2140 of charging station 1100. Power management unit 2140 comprises AC/DC converter 12143 to convert wind AC power 2812 into wind DC power 12813. Power management unit 2140 also comprises power management controller 12144 to combine wind DC power 2812 and solar DC power 2811 into combined DC power 2810, where combined DC power 2810 is made accessible to one or more system batteries 2110. Although the present example shows power generator 1200 as comprising more than one type of power generator, in the form of solar power generator 2210 and wind power generator 2220, there may be other examples where power generator 1200 comprises only a single type of power generator. Similarly, there may be examples where charging station 1100 may be configured to receive only one type of input power, such as only DC input power or AC input power, and/or such as only solar power or wind power. There can also be embodiments where charging station 1100 and/or power generator 1200 may be configured to receive input power form sources other than solar or wind energy.

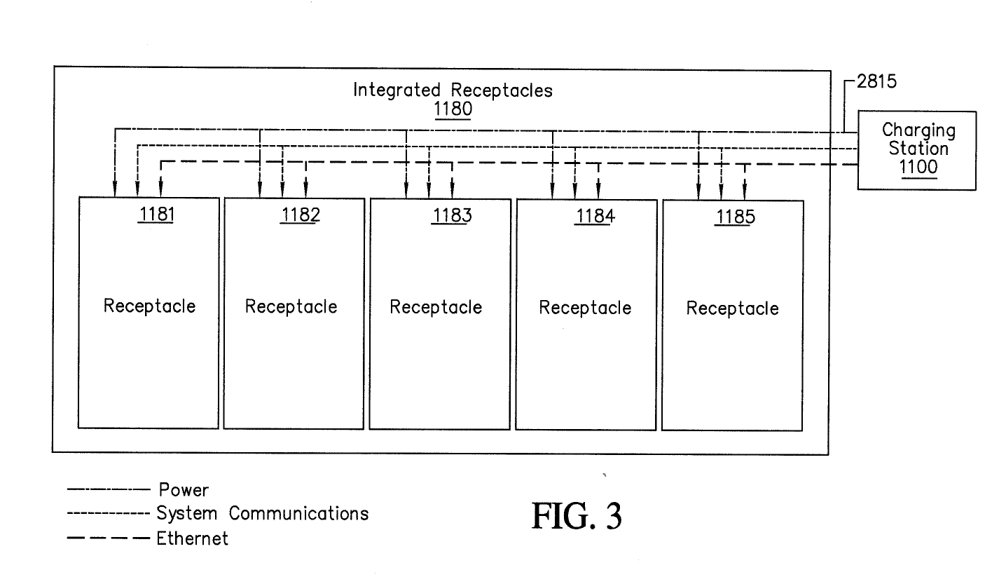

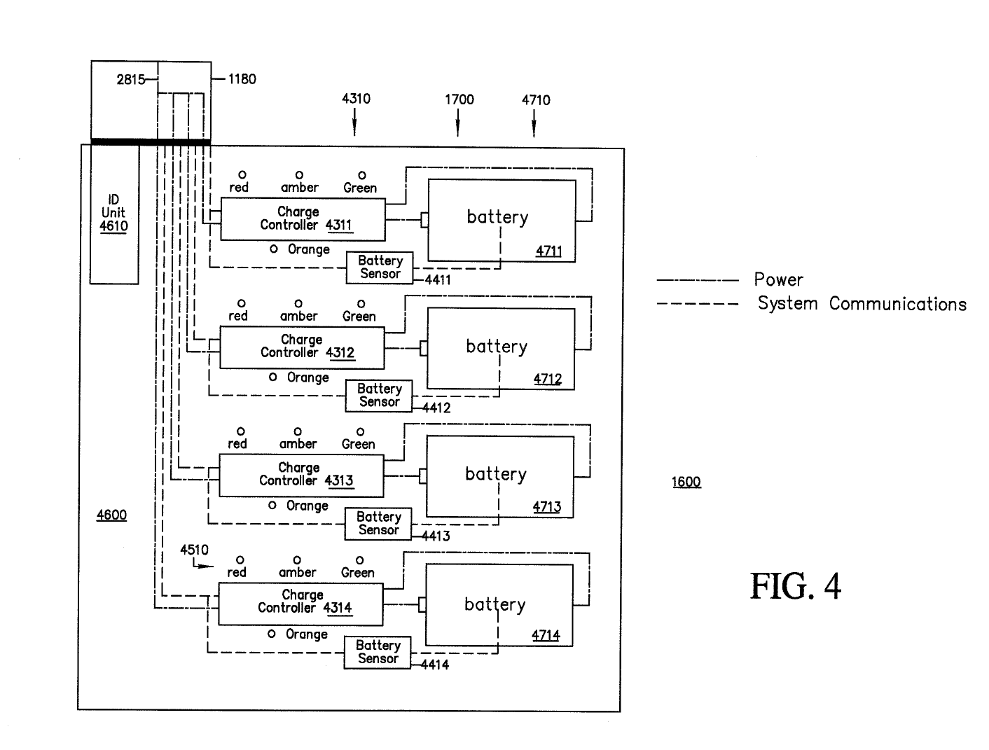

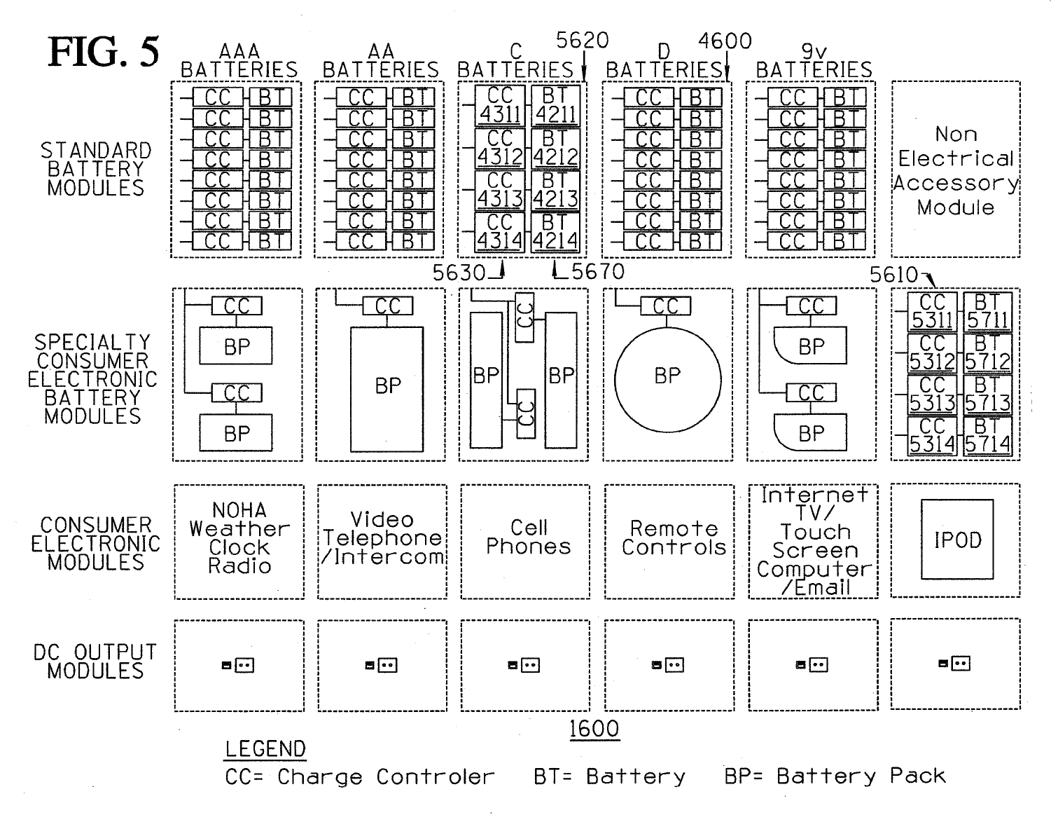

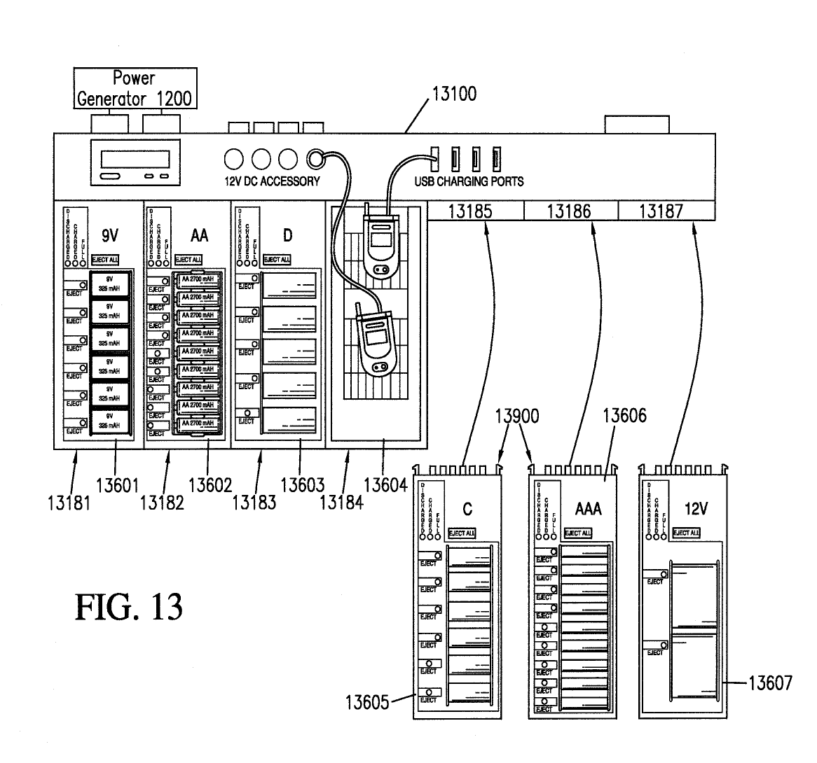

Returning to FIG. 1, in the present embodiment, charging system 1000 also comprises one or more charger modules 1600 configured to accommodate one or more rechargeable batteries 1700, and charging station 1100 comprises one or more receptacles 1180 configured to receive at least some of the one or more charger modules 1600. FIG. 3 illustrates a more detailed view of several receptacles 1180 of charging station 1100. FIG. 4 illustrates a schematic view of an exemplary charger module 4600 of the one or more charger modules 1600. FIG. 5 illustrates a schematic of several configurations for different charger modules 1600. Skipping ahead, FIG. 13 illustrates an implementation of how different charger modules 13601-13607 can be coupled to charging station 13100, where charging station 13100 can be similar to charging station 1100 (FIG. 1), and charger modules 13601-13607 can be similar to charger modules 1600 (FIG. 1, 4, 5).

In FIGS. 1 and 2, receptacles 1180 are configured to couple charger modules 1600 to charging station 1100. In the present example, each of receptacles 1180 has a standard height, width, and/or depth that is compatible with a corresponding height, width, and/or depth of charger modules 1600. As a result, one or more of charger modules 1600 can be interchangeably coupled to two or more different ones of receptacles 1180 to receive output power 2815 for their respective rechargeable batteries 1700, and to communicate with charging station 1100. In the same or other examples, charger modules 1600 may be swapped with one another between different ones of receptacles 1180. In the present example, any of the charger modules shown in FIGS. 4-5 can be configured to interchangeably couple with any of the receptacles shown in FIG. 3. In the implementation of FIG. 13, any of charger modules 13601-13607 can be interchangeably coupled with any of receptacles 13181-13187 of charging station 13100. As shown in FIG. 13, charger modules 13601-13607 can comprise snap-in couplers 13900 configured to electrically and mechanically attach to corresponding couplers of receptacles 13181-13187 for quick and secure mating with charging station 13100.

Charger modules 1600 are each configured to accommodate, and to individually and variably charge, one or more types of rechargeable batteries 1700. For example, as seen in FIG. 4, charger module 4600 is configured to accommodate 4 “D” type rechargeable batteries 4710, namely, batteries 4711, 4712, 4713, and 4714.

As seen in FIG. 5, other ones of battery modules 1600 may be configured for standard rechargeable batteries, such as for “AAA” batteries, “AA” batteries, “C” batteries, and/or 9-Volt batteries. In the same or other embodiments, other ones of charger modules 1600 may be configured for specialty consumer batteries, such as batteries designed for specific electric or electronic products like mobile phones, cameras, music players, electric lawn mowers, and/or power tools, among others. In some examples, a battery may be designed with an integrated charger module, such as to directly couple or “snap” onto one of receptacles 1180 (FIGS. 1-3). In the same or other embodiments, other ones of charger modules 1600 may be configured for consumer electronic devices having internal or embedded batteries, like weather clock/radios, video telephone/intercom devices, mobile phones, remote controls, mobile computers, or digital music players. In examples where a battery module 1600 is configured for a consumer electronic device, such battery module may accommodate or support part or all of a body of such consumer electronic device while its battery is charged. There can also be examples where a particular charger module can accommodate and charge more than one type of rechargeable batteries 1700. For example, charger module 5610 in FIG. 5 is configured to accommodate rechargeable batteries 5711-5712 and 5721-5722, where rechargeable batteries 5711-5712 are of a different type than rechargeable batteries 5721-5722, such as by comprising different dimensions and/or charge requirements.

Charger modules 1600 are also configured to charge rechargeable batteries 1700 using output power 2815 (FIG. 2) from charging station 1100. In the present example, output power 2815 is sourced from the storage charge of system battery 2110. There may be other embodiments, however, where output power for charging the rechargeable batteries may be sourced from system battery 1500, from combined DC power 2810 off power management unit 2140, and/or from input power 1810 from power generator 1200.

In the present embodiment, each of charger modules 1600 comprises a respective charge controller set 1300, and couples such respective charge controller set 1300 with one or more of respective rechargeable batteries 1700. Each charge controller set 1300 is configured to individually and variably charge one or more of respective rechargeable batteries 1700 using output power 2815. For example, as seen in FIG. 4, charger module 4600 comprises charge controller set 4310 coupled to rechargeable batteries 4710, such that charge controller 4311 variably charges rechargeable battery 4711, charge controller 4312 variably charges rechargeable battery 4712, charge controller 4313 variably charges rechargeable battery 4713, and charge controller 4314 variably charges rechargeable battery 4714. Other charger modules can comprise other charge controller sets configured to charge other battery sets of rechargeable batteries 1700. For example, charger module 5620 in FIG. 5 is configured for “C” type batteries, and comprises charge controller set 5630 configured to individually and variably charge respective batteries of battery set 5670. In some examples, a charger module may comprise more than one charge controller set, where each charge controller set may be configured for a different type of rechargeable battery. For example, charger module 5610 in FIG. 5 comprises charger module set with charge controllers 5311 and 5312 configured for the battery type of rechargeable batteries 5711-5712, respectively, and another charger module set with charge controllers 5321 and 5322 configured for the battery type of rechargeable batteries 5721-5722, respectively.

Each charge controller set 1300 of charger modules 1600, including charge controller set 4310 of charger module 4600, is controlled by system controller 2120 of charging station 1100 (FIG. 2). System controller 2120 controls concurrent transmission of output power 2815 to each of receptacles 1180, based on charger module parameters received from each of charger modules 1600 via receptacles 1180, so that rechargeable batteries 1700 may be variably charged as individually needed. Also in the present embodiment, charge controller sets 1300 at charger modules 1600 are configured to charge respective rechargeable batteries 1700 based on charging parameters received from system controller 2120, where the charging parameters from system controller 2120 are based on the charger module parameters received by system controller 2120 from respective charger modules 1600.

Using charger module 4600 of FIG. 4 as an example, each of battery sensors 4411-4414 sends respective charger module parameters of respective rechargeable batteries 4711-4714 to system controller 2120 (FIG. 2), and Identification Unit (ID unit) 4610 sends charger module parameters of charger module 4600 to system controller 2120 (FIG. 2). System controller 2120 (FIG. 2) then interprets such charger module parameters and sends charging parameters to charge controllers 4311-4314 to vary the charging of rechargeable batteries 4711-4714 as needed. Such two-way communication between charger modules 1600 and charging station 1100 results in more efficient charging of rechargeable batteries 1700.

Continuing with the example of charger module 4600 of FIG. 4, there can be embodiments where the charging parameters sent from system controller 2120 (FIG. 2) to charge controller set 4310 can comprise a charging rate and/or a charge intensity for individual ones of rechargeable batteries 4710. As a result, for example, charge controller 4311 may respond by charging rechargeable battery 4711 with a different charge intensity than the charge intensity provided by charge controller 4312 for rechargeable battery 4712. As another example, charge controller 4313 may respond by dropping the charging rate to zero for rechargeable battery 4713 if system controller 2120 detects, based on the charger module parameters it receives from charger module 4600, that such battery is fully charged.

In the same or other embodiments, the charger module parameters sent from charger module 4600 to system controller 2120 can comprise a battery type parameter, a battery quantity parameter, a battery temperature parameter, a battery charge parameter, and/or a battery chemistry parameter for rechargeable batteries 4710. In some embodiments, some of the charger module parameters may be sent by ID unit 4610. For example, ID unit 4610 may be configured with information regarding the battery type(s), battery chemistry, and/or number of batteries that charger module 4600 is designed to accommodate, and may accordingly send the battery type parameter and/or battery quantity parameter to system controller 2120. In the same or other embodiments, battery sensors 4411-4414 may be configured to sense the presence of batteries 4710, and/or temperatures or chemistries thereof, and may accordingly send the battery quantity parameter, the battery temperature parameter, and/or the battery chemistry parameter for each of rechargeable batteries 4710.

There can also be embodiments where system controller 2120 may be configured to determine one or more parameters of the batteries in a charger module such as charger module 4600. As an example, system controller 2120 may be configured to determine a battery chemistry parameter from one or more of the batteries in charger module 4600 based on how such battery reacts to certain tests. For instance, system controller 2120 may test how the battery reacts to charge/discharge tests, such as by running one or more short charge/discharge cycles on the battery via charger module 4600, and then determining how much charge from the charge/discharge cycles the battery retained, such as by querying a battery charge parameter from charger module 4600, to thereby establish the battery chemistry parameter for such battery. In some examples, software may be used by system controller 2120 to compare the charge retained by the battery from the charge/discharge cycles against expected charge retention statistics for different kinds of battery chemistries.

In embodiments like the one described above, system controller 2120 may also be configured such that a battery parameter determined by system controller 2120, such as the battery chemistry parameter described above, may substitute, replace, supplement, and/or override a battery parameter received from charger module 4600, such as a battery chemistry parameter from ID unit 4610.

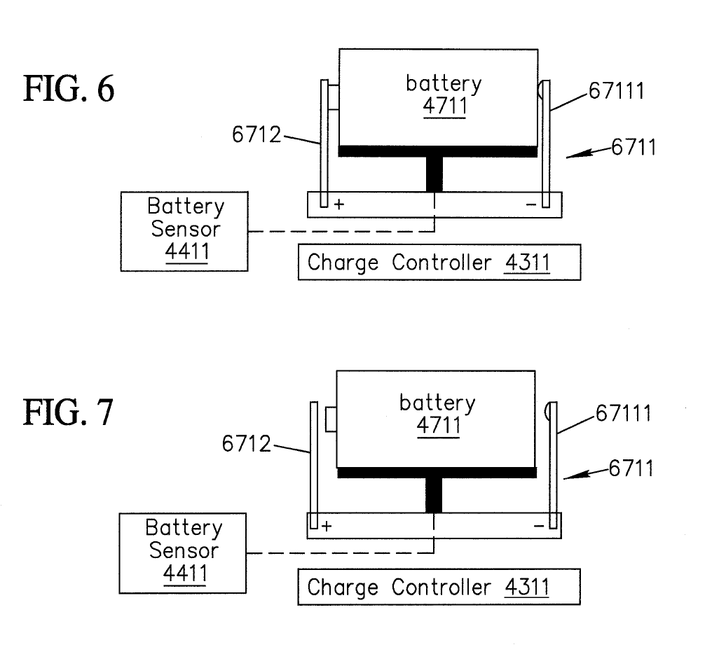

FIG. 6 illustrates a side view of battery charge coupler 6711 configured to couple battery 4711 to charge controller 4311 of exemplary charger module 4600. FIG. 7 illustrates a side view of battery charge coupler 6711 configured to decouple battery 4711 from charge controller 4311 of exemplary charger module 4600. In the present example, battery charge coupler 6711 is configured to couple battery 4700 to charger module 4600 and to hold battery 4711 in place to be charged via charge controller 4311 (FIG. 4). In some embodiments, battery charge coupler 6711 can be configured to couple rechargeable battery 4711 to charge controller 4311 when the rechargeable battery 4711 is partially charged and/or to decouple rechargeable battery 4711 from charge controller 4311 when rechargeable battery 4711 is fully charged. In the same or other embodiments, battery charge coupler 6711 can be configured to decouple rechargeable battery 4711 from charge controller 4311 if rechargeable battery 4711 is dysfunctional. There can be embodiments where the charge status of rechargeable battery 4711 can be periodically monitored to determine whether to couple or decouple rechargeable battery 4711 to or from charge controller 4311 via battery charge coupler 6711 as described above, where such monitoring may be carried out by charger module 4600 via battery sensor 4411 and/or through charge controller 4311. In some examples, battery charge coupler 6711 may couple rechargeable battery 4711 to charge controller 4311 by mechanically moving leads 67111 and 67112 to contact respective terminals of rechargeable battery 4711, as shown in FIG. 6. In the same or other examples, battery charge coupler 6711 may decouple rechargeable battery 4711 from charge controller 4311 by mechanically moving leads 67111 and 67112 away from respective terminals of rechargeable battery 4711, as shown in FIG. 7. In other embodiments, rechargeable battery 4711 may be coupled or decoupled via a switch or transistor that disables an electrical path to charge controller 4311, rather than by mechanically moving leads 67111 and 67112 relative to rechargeable battery 4711. In the same or other embodiments, such switch or transistor may be part of battery charge coupler 6711 and/or or charge controller 4311. Similar mechanisms and/or analyses for coupling or decoupling rechargeable batteries may be implemented for other charge controllers or battery charge couplers of charger module 4600, and/or for other charge controller sets or charger modules of charging system 1000 (FIG. 1).

As seen in FIG. 4, charger modules 1600 can comprise a status display indicative of one or more conditions for batteries 1700. For example, charger module 4600 comprises status display 4510 for rechargeable 4714. In the present example, different light colors may be exhibited by status display 4510 to indicate different conditions related to rechargeable battery 4714. As an example, one color may be indicative of whether rechargeable battery 4714 is discharged or has a low level of charge; another color may be indicative of whether rechargeable battery 4714 is fully charged; and another color may be indicative of whether charge controller 4314 is currently charging rechargeable battery 4714. In some examples, status display 4510 may also be configured to indicate whether battery 4714 is dysfunctional, and/or whether some other mechanical or electrical malfunction prevents battery 4714 from being properly charged. Similar status displays may be provided for other rechargeable batteries and/or charge controllers. In addition, there may be embodiments where other types of indicators different than colored lights may be used to indicate similar or different conditions for individual batteries and/or for charger modules.

As seen in FIG. 2, charging station 1100 also comprises integrated charger module 2160, which comprises one or more integrated power outlets 2161 coupled to system battery 2110 and configured to provide access to output power 2815 for devices that may be coupled to integrated power outlets 2161. In some examples, integrated power outlets 2161 may comprise one or more USB (Universal Serial Bus) outlets, and/or one or more car-type DC power outlets. Integrated charger module 2160 is in communication with system controller 2120, such that system controller 2120 may ascertain which of power outlets 2161 is in use and/or how much of output power 2815 is being used by power outlets 2161. With such information, considering the power requirements for charger modules 1600, system controller 2120 may determine how best to distribute output power 2815 to integrated charger module 2160 and/or to integrated receptacles 1180.

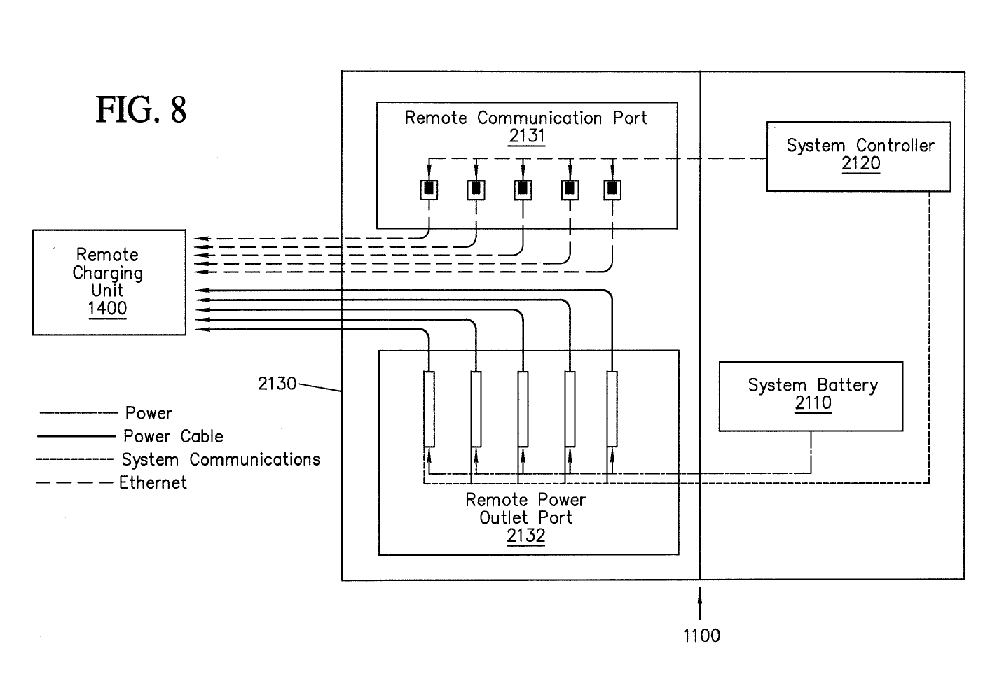

Charging system 1000 also comprises remote charging unit 1400 located remote of charging station 1100 in the present embodiment. FIG. 8 illustrates a schematic of remote charger port 2130 with exemplary wiring to couple remote charging unit 1400 to charging station 1100. Remote charging unit 1400 comprises remote receptacles 1480 configured to couple additional charger modules 1650 of charger modules 1600 to charging station 1100 to charge additional batteries 1750 of rechargeable batteries 1700. Charging station 1100 comprises remote charger port 2130 (FIG. 2), with remote power outlet port 2132 to electrically couple remote charging unit 1400 to system battery 2110, and with remote communication port 2131 to communicatively couple remote charging unit 1400 to system controller 2120.

In the present example, remote communication port 2131 comprise RJ-45 (Ethernet) ports configured to carry data or parameters between remote charging unit 1400 and system controller 2120. In other examples, different types of communication ports may be used, such as RJ-11 (telephone) ports, or wireless ports. Also in the present example, remote power outlet port 2132 are configured to supply DC power from system battery 2110 for the additional charger modules 1650 coupled to remote charging unit 1400. Remote power outlet port 2132 may also be coupled to system controller 2120, where system controller 2120 may manage or adjust the amount of DC power sent to individual ones of remote power outlet port 2132 based on information or parameters received from remote charging unit 1400 about the additional charger modules 1650 coupled thereto. There may be other examples where remote charging unit 1400 comprises its own system battery similar to system battery 2110, and/or its own power generator similar to power generator 1200. In such examples, remote charging unit 1400 may still couple with charging station 1100 via remote charger port 2130 so that the operation of additional charger modules 1650 can still be managed or controlled by system controller 2120.

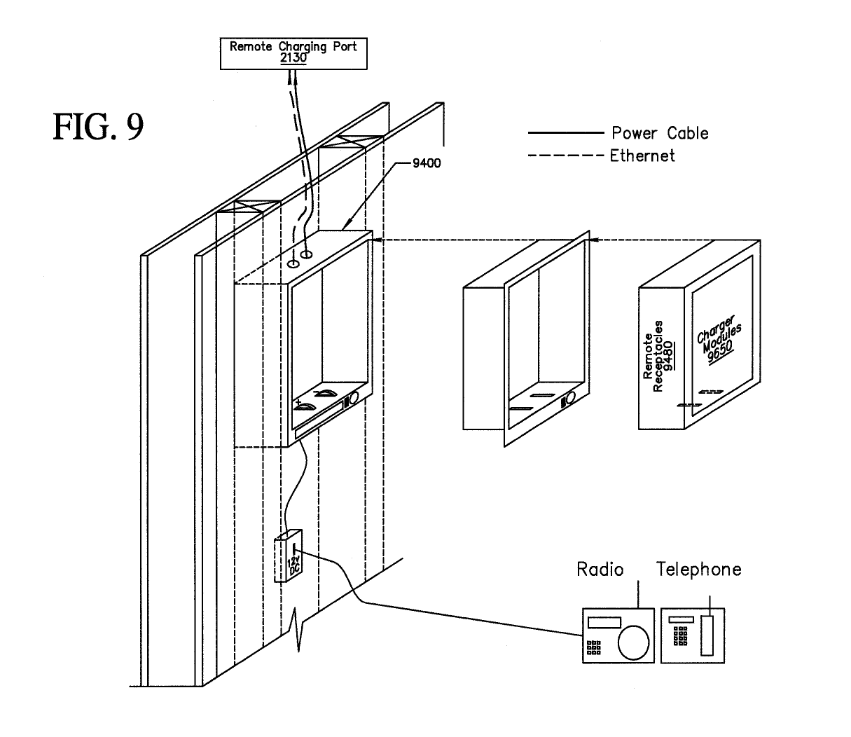

FIG. 9 illustrates a scenario of how remote charging unit 9400 may be installed remotely from charging station 1100 to support additional charger modules 9650 via remote receptacles 9480. In the example of FIG. 9, remote charging unit 9400 is integrated into a wall of a building, but there can be other examples where remote charging unit 9400 is external to the wall and/or comprises a different configuration along with remote receptacles 9480 and charger modules 9650. Remote charging unit 9400, remote receptacles 9480, and charger modules 9650 may be otherwise similar to remote charging unit 1400, remote receptacles 1480, and charger modules 1650, respectively (FIG. 1).

In the present example, as seen in FIG. 1, charging station 1900 may also be coupled as part of charging system 1000. Charging station 1900 may be similar to charging station 1100, and may be configured to support other receptacles similar to receptacles 1180, charger modules similar to charger modules 1600, and/or other remote charging units similar to remote charging unit 1400. In the present example, as seen in FIG. 2, charging station 1900 is coupled to power management unit 2140 via DC output port 2150 to receive DC power from power generator 1200.

As previously described, power management unit 2140 is configured to charge system battery 2110 with combined DC power 2810 derived from power generator 1200. When system battery 2110 is fully charged, power management unit 2140 may terminate excess power from combined DC power 2810 if not needed for supplying additional system battery port 2170, integrated charger module 2160, remote charger port 2130, and/or receptacles 1180. The excess power may be terminated by grounding. In cases where charging station 1900 or another device is coupled to DC output port 2150, the excess power may be routed to DC output port 2150 for consumption or storage in charging station 1900.

There can be other embodiments, however, where charging station 1900 may couple directly to power generator 1200 to receive a portion of input power 1810. Even in such embodiments, however, charging station 1900 may still couple with charging station 1100 to share information like usage statistics or other parameters that may be used by system controller 2120 to regulate the operation of charging station 1100 and/or to transmit such statistics or parameters via network module 2121 (FIG. 2). In the same or other embodiments, charging station 1900 may couple to its own power generator, which may be similar to power generator 1200. In such embodiments, system 1000 may be configured such that power from charging station 1900 may also be shared with charging station 1100 if needed.

Although remote charging unit 9400 is shown in FIG. 9 as integrated into a wall, similar to a breaker box, other form factors may be used for charging units and/or charging stations. For example, FIG. 13 illustrates a view of charging station 13100 in a power strip configuration. In the example of FIG. 13, charging station 13100 comprises receptacles 13181-13187, which can be similar to receptacles 1180 of charging station 1100 (FIGS. 1, 3). Charging station 13100 also comprises charger modules 13601-13607, similar to charger modules 1600 (FIGS. 1, 4, 5), configured to interchangeably and removably couple with receptacles 13181-13187, and to accommodate and charge different types of batteries and electronic devices.

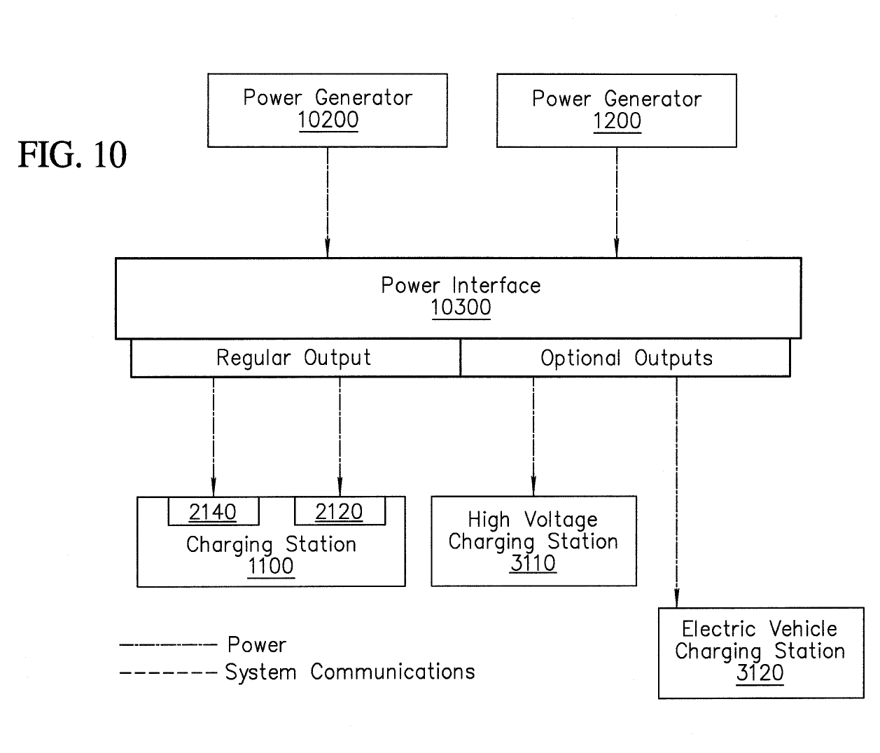

In some embodiments, charging system 1100 may be expanded for extra power capacity. For example, FIG. 10 presents an optional power interface unit 10300 that may be coupled to charging station 1100 and to power generator 1200, where power interface unit 10300 can permit another power generator 10200, similar to power generator 1200, to be coupled to charging station 1100 for increased current and/or power. Power interface unit 10300 may merge the power from both power generators 1200 and 10200 and route it to power management module 2140 of charging station 1100. In the same or other embodiments, power interface unit 10300 may provide the merged power to other power outputs, such as high voltage charging station 3110, and/or for electric vehicle battery charging station 3120, where the extra power capacity afforded by power interface unit 10300 may be used to charge batteries or systems requiring higher voltages or capacities than those required for rechargeable batteries 1700 of charging station 1100.

In some implementations, such high voltage charging stations 3110 or electric vehicle battery charging stations 3120 may be coupled to charging systems located at specialty locations, such as at gas stations or other retail outlets where customers could benefit from such availability of charging stations like charging station 1100. In the same or other examples, kiosks could be configured to provide customers with charged batteries for a fee, and/or in exchange for discharged batteries. In the same or other examples, batteries such as batteries 1700 or other batteries configured to be charged by high voltage charging station 3110 and/or by electric vehicle charging station 3120 may comprise an identification device, such as an RFID (Radio Frequency Identification) chip and/or other optical mechanism, such as barcodes, to be identifiable by charging station 1100 or by other charging stations to which they may be coupled. Charging station may thus gather information about the batteries' history and health, and/or about customer usage statistics. Such battery information may also be relayed by charging station 1100 to a remote database, such as computer 1710, and or to a management application, like management application 1711, as described below with respect to network 1700 (FIG. 1).

Charging station 1100 may be configured in some embodiments to prioritize charging of one or more priority batteries, relative to other batteries chargeable by charging system 1000, when the priority battery is selected to designate its priority status. In some examples, a user may instruct charging station 1100 to designate a specific battery as the priority battery, and/or charging station 1100 may be configured to recognize such specific battery as the priority battery when coupled thereto. In some examples, the priority battery may be one of rechargeable batteries 1700. In the same or other examples, the priority battery may be one of the batteries coupled to one of modules 1600, including batteries as described above and as illustrated with respect to the charger modules of FIG. 5. The priority battery may also be a battery of a device coupled to one of power outlets 2161 (FIG. 2) or other outlets of charging station 1100.

There can be embodiments where system controller 2120 may be configured to control transmission of a supplemental power to the priority battery, when the priority battery is selected, where such supplemental power can be routed from other batteries, such as from rechargeable batteries 1700, to supplement and/or substitute output power 2815 deliverable to the priority battery from system battery 2110.

In the present example of charger system 1000, charger station 1100 comprises network module 2121, which can be part of system controller 2120, configured to access network 1700. Network 1700 can comprise a wired network such as an Ethernet network, a wireless network such as a Wi-Fi network based on, for example, IEEE 802.11 standards, and/or a combination wired/wireless network. System controller 2120 also comprises several software modules, such as an operating system module 2411, a system software module 2422, and/or a charging software module 2423. In some examples, such software modules may be stored in non-volatile memory 2410 of system controller 2120, such as in a PowerArmor solid state drive from Western Digital Corporation, of Irvine, Calif. Via the system or charging software, system controller 2120 may be configured to control the distribution and storage of power received from power generator 1200 amongst the different elements and ports of charging station 1100, based on battery parameters and/or other information received at board interface 2122 from such different elements and ports.

In some examples, the system and/or charging software may have pre-programmed information regarding charging requirements for different kinds of batteries and/or electronic devices. In the same or other examples, such charging requirements may be received from charger modules 1600, such as from ID unit 4610 of charger module 4600 (FIG. 4). In addition, the software modules of system controller 2120 may receive real-time and independent updates on battery parameters, such as battery chemistry and battery temperatures, for the different batteries coupled to charging station 1100. In response to such combination of information, system controller 2120 may adjust the charging of individual batteries or sets of batteries to, for example, minimize charge times, and/or maximize battery life.

System controller 2120 also comprises a user interface module 2510 where users can interact with charging station 1100, such as for controlling functions of charging station 1100, querying data from charging station 1100, and/or for establishing a network connection for charging station 1100. In some examples, interface module 2510 can comprise a keypad, touchscreen, and/or other input device for the user to communicate with system controller 2120. There can be examples where interface module 2510 can permit users to enter alphanumeric characters, and/or actuate navigation arrows, to select or establish different options for charging station 1100. There can also be examples where interface module 2510 may be accessed via external devices coupled to charging station 1100. For example, an external keyboard or peripheral device, and/or an external computer such as a laptop, may be coupled to charging station 1100, such as via a USB outlet of integrated power outlets 2161, to interact with interface module 2510.

In some examples, user interface module 2510 may permit users to select a quick charge to a specific battery coupled to charging station 1100, to activate or deactivate components or modules coupled to charging station 1100, to receive estimated charging times for individual batteries and/or for groups of batteries, to input charging parameters for specific batteries, and/or to retrieve system usage and operating statistics, such as the amount of electricity saved, power input parameters from solar power generator 2210 and/or wind power generator 2220, battery status parameters, among others.

As seen in FIG. 1, charging system 1000 may be configured to interface with management application 1711 at computer 1710, where management application 1711 couples to charging station 1100 via network module 2121 of system controller 2120 (FIG. 2) through network 1700. Computer 1710 may be any kind of computer, such as a workstation, server, desktop, laptop, and/or mobile computer/phone. Management application 1711 may also correspond with, and/or be accessible through, a website or other Internet-connected application, such as website 1720.

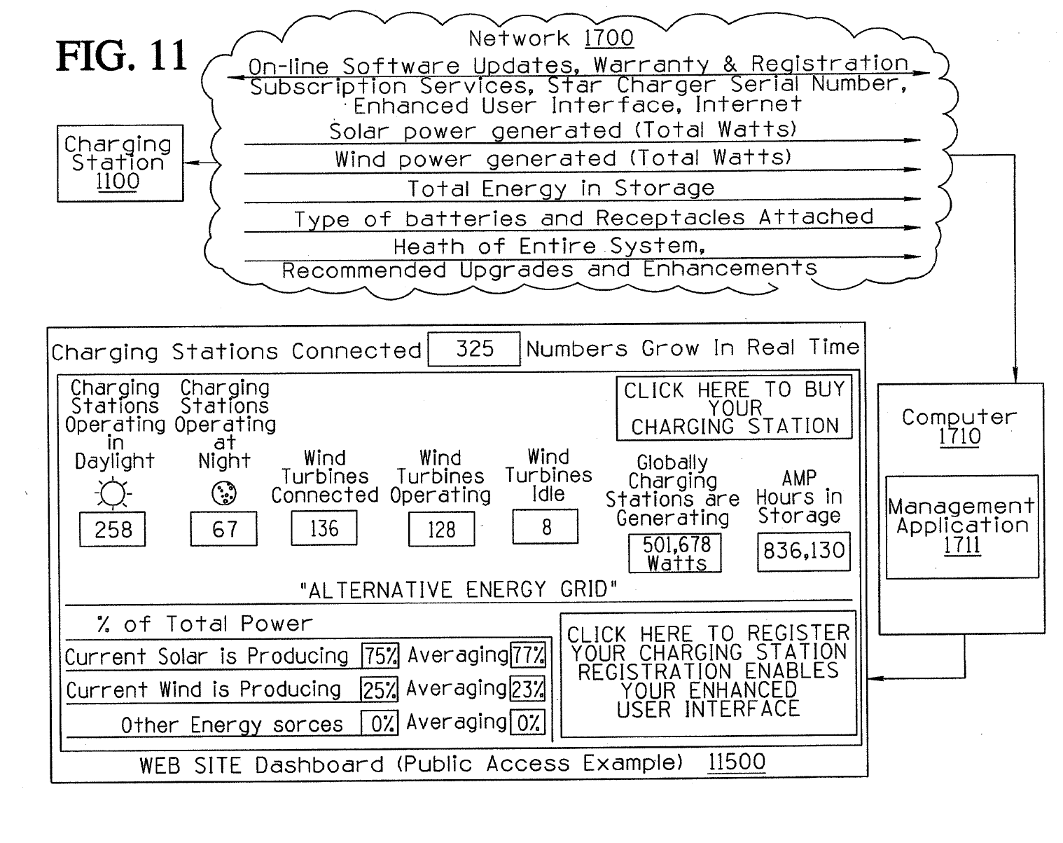

Management application 1711 is configured to receive real-time information from system controller 2120 regarding the status of charging system 1000. In some examples the system information may comprise data regarding the number of charger modules 1600 coupled to charging station 1100, the number of rechargeable batteries 1700 coupled to charging station 1100 via charger modules 1600, battery types for such rechargeable batteries 1700, charge information for such rechargeable batteries 1700, the magnitude of input power 1810 and/or of combined DC power 2810 (FIG. 2), and/or the magnitude of the storage charge of system battery 2110, among other types of data regarding the status and/or consumption of different elements that may couple to charging station 1100, as described above. Based on such received system information, management application 1711 may present such system information, and/or process such system information, to generate and present further system information such as a real-time system summary display or dashboard for charging station 1100 and/or for charging system 1000 (FIG. 1). FIG. 11 illustrates a sample graphical user interface (GUI) 11500 of management application 1711 showing a “dashboard” display or system summary information for charging system 1000. In the screen presented in FIG. 11, system information about additional charging stations has been aggregated with the information from charging station 1100 to present a combined system summary of all such charging stations in communication with management application 1711.

Other screens of management application 1711 may present information concerning other elements of charging system 1000, like information about individual charging stations, such as charging station 1100, information about individual receptacles, such as receptacles 1180, information about individual charger modules, such as charger modules 1600 (FIG. 1) and/or 4600 (FIG. 4), information about individual charge controllers and/or charge controller sets, such as charge controller sets 1300 (FIG. 1) and/or charge controller 4314 (FIG. 4), and/or information about individual battery sets or batteries, such as rechargeable batteries 1700 (FIG. 1) and/or rechargeable battery 4714 (FIG. 4).

In some embodiments, management application 1711 may provide further options for a user. For example, management application 1711 may determine, based on the received system information, that a software update is available for charging station 1100 or for other elements of charging system 1000, and may provide the user with an option for upgrading to such software update. Management application 1711 may also offer the user an option to register for subscription services for charging station 1100 and/or for other elements of charging system 1000. Such subscription services may, for example, give users access to further features of management application 1711, such as features for monitoring or controlling individual elements of charging system 1000, as described above. Management application 1711 may also offer upgrade recommendations for the user based on the received system information. For example, an upgrade recommendation may suggest to add to charging system 1000 additional system batteries 1500, further solar panels 2211 (FIG. 2) to solar power generator 2210, or another power generator 1200, if the power requirements of charging system 1000 start to exceed the current level provided by power generator 1200 and/or system battery 2110 (FIGS. 1-2).

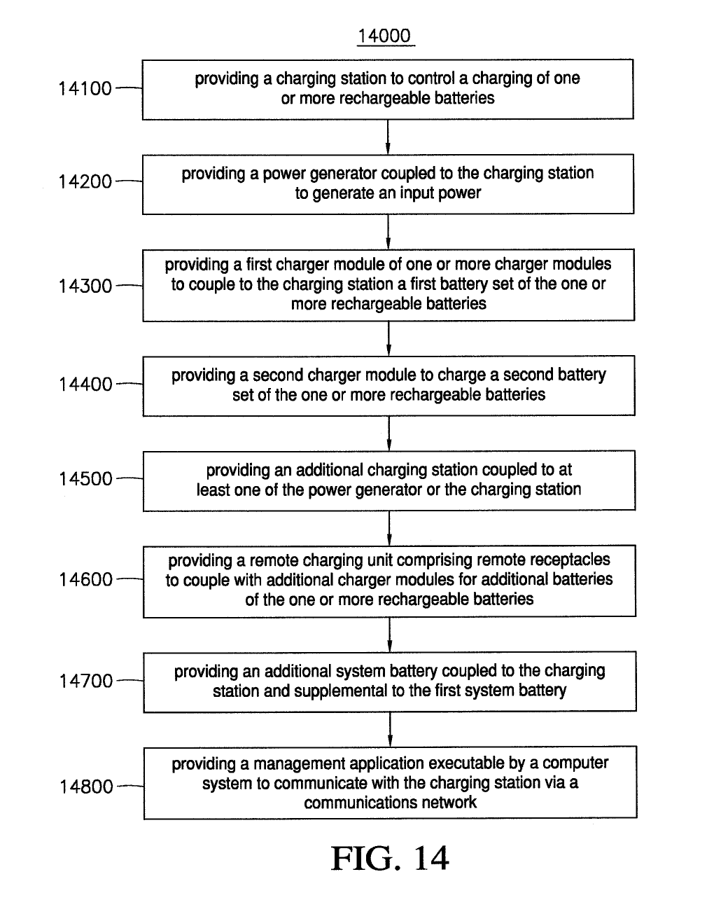

Moving ahead, FIG. 14 illustrates a flowchart of a method 14000 for providing a charging system. In some examples, the charging system of method 14000 can be similar to charging system 1000 and/or to other similar charging systems as described above.

Block 14100 of method 14000 comprises providing a charging station to control a charging of one or more rechargeable batteries. In some examples, the charging station can be similar to charging station 1100 (FIGS. 1-2) and/or charging station 13100 (FIG. 13). In the same or other examples, the rechargeable batteries can be similar to rechargeable batteries 1700 (FIG. 1), 4710 (FIG. 4), the rechargeable batteries shown and/or described with respect to FIG. 5, and/or other batteries chargeable by charging station 1100, such as batteries configured to be charged by high-voltage charging station 3110 (FIG. 10) and/or by electric vehicle charging station 3120 (FIG. 10).

Block 14200 of method 14000 comprises providing a power generator coupled to the charging station to generate an input power for the charging station. In some examples, the power generator can be similar to power generator 1200 (FIGS. 1-2), and the input power can be similar to input power 1810 (FIGS. 1-2).

Block 14300 of method 14000 comprises providing a first charger module of one or more charger modules to couple to the charging station a first battery set of the one or more rechargeable batteries. In some examples, the first charger module can be similar to one of charger modules 1600 (FIGS. 1, 4, 5), like charger module 4600 (FIG. 4). In some examples, method 14000 can also comprise block 14400 for providing a second charger module to charge a second battery set of the one or more rechargeable batteries. Like the first charger module of block 14300, the second charger module can be similar to one of charger modules 1600 (FIGS. 1, 4, 5), like charger module 4600 (FIG. 4).

In some examples, providing the power generator in block 14200 can comprise providing a solar power generator to convert a solar energy to a solar power for the input power to the charging station. There can be examples where the solar power generator can be similar to solar power generator 2210 (FIG. 2). In the same or other examples, providing the power generator can comprise providing a wind power generator to convert a wind energy to a wind power for the input power to the charging station. The wind power generator may be in addition to, or in lieu of, the solar power generator, and may be similar to wind power generator 2220 (FIG. 2). There can also be examples where providing the charging station in block 14100 can comprise providing a power management unit configured to couple the input power from the power generator to a system battery of the charging station, and/or to combine the solar power and the wind power into the input power. In some examples, the power management unit can be similar to power management unit 2140 (FIG. 2).

Providing the charging station in block 14100 can comprise, in some examples, providing a first system battery to collect a storage charge derived from the input power, providing one or more receptacles configured to couple the one or more charger modules to the charging station, and providing a system controller to control an output power to each of the one or more receptacles based on charger module parameters received from the one or more charger modules. The output power may be routed to the one or more charger modules coupled to the one or more receptacles, and the system controller of the charging station may control or vary the output power based on which charger modules are coupled and their respective power requirements. In such examples, the first system battery can be similar to system battery 2110 (FIG. 2), the receptacles can be similar to receptacles 1180 (FIGS. 1, 3), receptacles 9480 (FIG. 9), or receptacles 13181-13187 (FIG. 13). The system controller can be similar to system controller 2120 (FIG. 2). The output power can be similar to output power 2815 from system battery 2110 (FIG. 2).

Providing the first charger module in block 14300, or the second charger module in block 14400, can comprise configuring the first and/or second charger module to interchangeably couple to the charging station via a first and/or a second receptacle selectable from the one or more receptacles. For instance, the first charger module may couple to either of the first or second receptacles, and the second charger module may likewise couple to either of the first or second receptacles. In some examples, the first and/or second charger modules may couple to the first and/or second receptacles as described above with respect to charger modules 1600 (FIGS. 1, 2, 4, 5) coupling to receptacles 1180 (FIGS. 1-3), with respect to charger modules 9650 coupling to receptacles 9480 (FIG. 9), and/or charger modules 13601-13607 coupling to receptacles 13818-13187. The first or second charger modules may comprise respective battery charge couplers to couple with and/or accommodate respective rechargeable batteries, where such charge couplers may be similar to charge coupler 6711 (FIGS. 6-7) in some examples.

Providing the first charger module in block 14300 also can comprise, in some examples, providing a first battery charge controller set to (a) couple with one or more batteries of the first battery set, (b) receive charging parameters from the system controller for each of the one or more batteries of the first battery set, and/or (c) variably charge each of the one or more first batteries, based on the charging parameters from the system controller, with the output power received at the first receptacle. In some examples, the first battery charge controller set can be similar to charge controller set 1300 (FIG. 1), and/or to charge controller set 4310 (FIG. 4). In the same or other examples, the charging parameters can be generated by the system controller based on the charger module parameters from the first charger module, as described above with respect to the charging parameters sent by system controller 2120 (FIG. 2) to charge controller set 1300 (FIG. 1) and/or charge controllers 4311-4314 (FIG. 4).

In some examples, method 14000 can also comprise block 14500 for providing an additional charging station coupled to at least one of the power generator of block 14200 and/or or to the charging station of block 14100. There can be implementations where the additional charging station can be similar to charging station 1900 (FIG. 1).

In some examples, method 14000 can also comprise block 14600 for providing a remote charging unit comprising remote receptacles to couple with additional charger modules for additional batteries of the one or more rechargeable batteries. There can be implementations where the remote charging unit, the remote receptacles, the additional charger modules, and/or the additional batteries can be respectively similar to remote charging unit 1400 (FIG. 1), remote receptacles 1480 (FIG. 1), additional charger modules 1650 (FIG. 1), and/or additional batteries 1750 (FIG. 1).

In some examples, method 14000 can also comprise block 14700 for providing an additional system battery coupled to the charging station and supplemental to the first system battery. There can be implementations where the additional system battery can be similar to additional system battery 1500 (FIG. 1).

In some examples, method 14000 can also comprise block 14800 for providing a management application executable by a computer system to communicate with the charging station via a communications network. There can be implementations where the management application can be similar to management application 1711 communicating with the charging station 1100 via a network 1700 (FIG. 1). In such examples, the charging station may comprise a network access mechanism similar to network module 2121 (FIG. 2) to access the network. The management application may be configured to display information regarding the charging station and/or the charging system in general, based on system information received from the charging station. In some examples, the management application may be executed from a computer system similar to computer 1710, and/or accessible via an internet-connected application like website 1720 (FIG. 1). The management application may also present information in a GUI display of one or more screens, like GUI 11500 (FIG. 11).

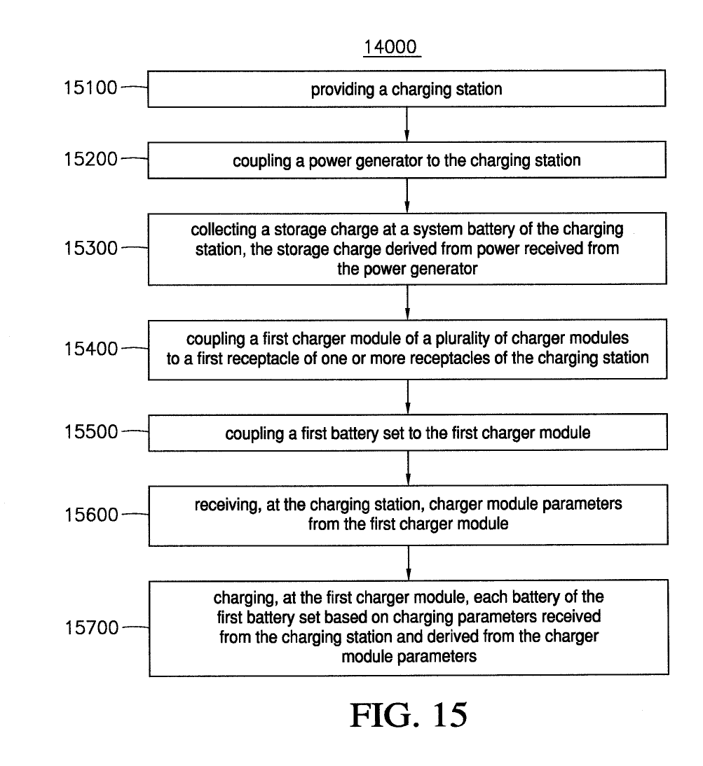

Moving on, FIG. 15 illustrates a flowchart of a method 15000 for using a charging system. In some examples, the charging system can be similar to charging system 1000 (FIG. 1).

Method 15000 comprises block 15100 for providing a charging station, and block 15200 for coupling a power generator to the charging station. In some examples, the charging station can be similar to charging station 1100 (FIG. 1), and the power generator can be similar to power generator 1200 (FIGS. 1-2).

Method 15000 also comprises block 15300 for collecting a storage charge at a system battery of the charging station, the storage charge derived from power received from the power generator. In some examples, the system battery can be similar to system battery 2110 (FIG. 2).

Block 15400 of method 15000 comprises coupling a first charger module of a plurality of charger modules to a first receptacle of one or more receptacles of the charging station. In some examples, the first charger module can be similar to one of charger modules 1600 (FIGS. 1, 2, 4, 5), such as charger module 4600 (FIG. 4), and/or similar to charger module 9650 (FIG. 9) or one or charger modules 13601-13607 (FIG. 13). The first receptacle can be similar to one of receptacles 1180 (FIGS. 1, 4), receptacles 9480 (FIG. 9), and/or receptacles 13181-13187 (FIG. 13).

Block 15500 of method 15000 comprises coupling a first battery set to the first charger module. There can be embodiments where the first battery set can be similar to at least a portion of rechargeable batteries 1700 (FIG. 1), such as rechargeable batteries 4710 (FIG. 4), and/or respective batteries of charger modules 1600 as described above in FIG. 5, for example.

Block 15600 of method 15000 comprises receiving, at the charging station, charger module parameters from first charger module. In some examples, the charger module parameters may be similar to the charger module parameters sent from charger modules 1600 to system controller 2120, as described above with respect to charging station 1100 (FIGS. 1-2) and charger module 4600 (FIG. 4), for example.

Block 15600 of method 15000 comprises receiving, at the charging station, charger module parameters from first charger module. In some examples, the charger module parameters may be similar to the charger module parameters sent from charger modules 1600 to system controller 2120, as described above with respect to charging station 1100 (FIGS. 1-2) and charger module 4600 (FIG. 4), for example.

Block 15700 of method 15000 comprises charging, at the first charger module, each battery of the first battery set based on charging parameters received from the charging station and derived from the charger module parameters. In some implementations, the charging parameters may be similar to the charging parameters sent from system controller 2120 to charger modules 1600, as described above with respect to charging station 1100 (FIGS. 1-2) and charger module 4600 (FIG. 4), for example.

In some examples, one or more of the different blocks of methods 14000 and/or 15000 can be combined into a single block or performed simultaneously, and/or the sequence of such blocks can be changed. For instance, blocks 14200 and 14300 of method 14000 may be performed simultaneously in some examples, and/or the sequence of blocks 14100 and 14200 may be reversed in the same or other examples. As another example, the sequence of blocks 15400 and 15500 of method 15000 may be reversed in some examples, and/or blocks 15200 and 15400 may be performed simultaneously in the same or other examples.

In the same or other examples, some of the blocks of methods 14000 and/or 15000 can be subdivided into several sub-blocks. For example, block 14200 of method 14000 may be subdivided in to respective sub-blocks for providing a solar power generator like solar power generator 2210, and/or for providing a wind power generator like wind power generator 2221 (FIG. 2). As another example, block 15100 of method 15000 can be subdivided into respective sub-blocks for providing a first charging station, like charging station 1100, for providing a remote charging unit, like remote charging unit 1400, and/or for providing an additional charging station, like charging station 1900 (FIG. 1).

There can also be examples where methods 14000 and/or 15000 can comprise further or different blocks. As an example, method 15000 may comprise a block for interfacing the charging station through a management application, like management application 1711 (FIGS. 1, 11). In addition, there may be examples where methods 14000 and/or 15000 may comprise only part of the blocks described above. For instance, blocks 14400, 14500, 14600, 14700, and 14800 may be optional for method 14000. Other variations can be implemented for methods 14000 and/or 15000 without departing from the scope of the present disclosure.

Although the battery charging systems and related methods herein have been described with reference to specific embodiments, various changes may be made without departing from the spirit or scope of the present disclosure. For example, in one embodiment, power generator 1200 may comprise a different kind of power generator other than solar power generator 2210 or wind power generator 2220 (FIG. 2), such as a thermoelectric power generator and/or a hydropower generator. In the same or other embodiments, power generator 1200 may comprise or be supplemented by power from a standard wall power outlet, including wall power outlets powered from renewable sources, such as solar panels powering a building where the charging station is located.

Accordingly, the disclosure of embodiments herein is intended to be illustrative of the scope of the invention and is not intended to be limiting. It is intended that the scope of this application shall be limited only to the extent required by the appended claims. The battery charging systems and related methods discussed herein may be implemented in a variety of embodiments, and the foregoing discussion of certain of these embodiments does not necessarily represent a complete description of all possible embodiments. Rather, the description herein, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a charging station configured to control a charging of one or more rechargeable batteries;
a power generator coupled to the charging station and configured to generate an input power; and
a first charger module of one or more charger modules configured to couple to the charging station;
wherein:
the power generator comprises:
a solar power generator configured to convert a solar energy to a solar DC power portion of the input power;
the charging station comprises:
a first system battery configured to collect a storage charge derived from the input power;
one or more receptacles configured to couple the one or more charger modules to the charging station; and
a system controller configured to control a concurrent transmission of an output power to each of the one or more receptacles based on charger module parameters of the one or more charger modules;
the output power is sourced from the storage charge of the first system battery;
the first charger module comprises a first battery charge controller set configured to individually and variably charge, with the output power received at a first receptacle of the one or more receptacles, one or more first batteries of a first battery set of the one or more rechargeable batteries;
the first battery charge controller set comprises a first battery charge controller;
the one or more first batteries comprises a first battery; and
the first charger module is configured to:
interchangeably couple to the charging station via the first receptacle; and
couple the first battery charge controller set with the first battery set.

2. The system of claim 1, wherein:
the first battery charge controller set is configured to charge the first battery set based on charging parameters received from the system controller; and
the charging parameters from the system controller are based on the charger module parameters received by the system controller from the first charger module.

3. The system of claim 2, wherein:
the charging parameters comprise, for each of the one or more first batteries of the first battery set, at least one of:
a charging rate; or
a charge intensity.

4. The system of claim 1, wherein:
the charger module parameters comprise at least two of:
a battery type of the first battery set;
a battery quantity of the first battery set;
a battery temperature of each of the one or more of the first batteries;
a battery charge of each of the one or more first batteries; or
a battery chemistry of each of the one or more of the first batteries.

5. The system of claim 1, wherein:
the one or more receptacles comprise a plurality of receptacles; and
the first charger module is configured to interchangeably couple to two or more of the plurality of receptacles.

6. The system of claim 1, wherein:
the first charger module comprises:
a first battery coupler set configured to couple the first battery set to the first charger module.

7. The system of claim 6, wherein:
the first charger module comprises:
a first battery sensor set configured to couple to the first battery set via the first battery coupler set, the first battery sensor set comprising:
a first battery sensor coupled to a first battery coupler of the first battery coupler set and configured to:
sense a first battery parameter comprising at least one of:
a presence of the first battery at the first battery coupler;
a battery temperature of the first battery;
a battery charge of the first battery; or
a battery chemistry of the first battery; and
forward the first battery parameter to the system controller as part of the charger module parameters.

8. The system of claim 7, wherein:
the system controller is configured to generate a first charging parameter for the first battery based on the first battery parameter received from the first battery sensor; and
the first battery charge controller is coupled to the first battery and configured to:
receive the first charging parameter from the system controller; and
charge the first battery based on the first charging parameter.

9. The system of claim 1, wherein:
the first charger module comprises:
a second battery charge controller set configured to individually and variably charge one or more second batteries of a second battery set of the one or more rechargeable batteries; and
the first and second battery sets comprise different battery types.

10. The system of claim 1, further comprising:
a second charger module comprising:
a second battery charge controller set configured to individually and variably charge one or more second batteries of a second battery set of the one or more rechargeable batteries;
wherein the second charger module is configured to interchangeably couple to the charging station via either of:
the first receptacle; or
a second receptacle selectable from the one or more receptacles.

11. The system of claim 1, wherein:
the first charger module further comprises:
a status display for each of the one or more first batteries, the status display comprising at least two of:
a low charge indicator;
a charging-in-progress indicator;
a full charge indicator; or
a battery malfunction indicator.

12. The system of claim 1, wherein:
the first charger module comprises:
a first battery charge coupler configured to:
couple the first battery to the first battery charge controller to charge the first battery when the first battery is partially charged; and
decouple the first battery from the first battery charge controller when the first battery is fully charged.

13. The system of claim 12, wherein:
the first battery charge coupler is configured to:
decouple the first battery from the first battery charge controller when the first battery is dysfunctional.

14. The system of claim 12, wherein:
the first charger module is configured to periodically sense a charge status of the first battery to determine whether to decouple the first battery from the first battery charge controller via the first battery charge coupler.

15. The system of claim 1, further comprising:
an integrated charger module non-removably attached to the charging station and comprising:
one or more integrated power outlets coupled to the first system battery and configured to provide access to the output power;
wherein the integrated power outlets comprise at least one of:
a USB outlet; or
a car-type DC power outlet.

16. The system of claim 1, further comprising:
a second system battery coupled and supplemental to the first system battery;
wherein the second system battery is external to the charging station.

17. The system of claim 1, further comprising:
a remote charging unit located remotely from the charging station;
wherein the charging station comprises a remote charger port configured to couple the remote charging unit to the system controller and to the first system battery.

18. The system of claim 17, wherein:
the remote charging unit comprises one or more remote receptacles configured to couple additional ones of the one or more charger modules to the charging station to charge additional ones of the one or more rechargeable batteries.

19. The system of claim 1, further comprising:
a second charging station;
wherein the charging station comprises a DC output coupler to couple the second charging station to the charging station.

20. The system of claim 1, wherein:
the charging station comprises:
a power management unit coupled to the power generator to:
couple the input power from the power generator to the first system battery; and
at least one of:
terminate an excess power of the input power; or
forward the excess power to a DC output port of the charging station.

21. The system of claim 20, wherein:
the power generator further comprises:
a wind power generator to generate a wind power from a wind energy;
at least one of the wind power generator or the power management unit comprise:
an AC/DC converter to convert the wind power to a wind DC power;
the power management unit is configured to combine the solar DC power and the wind DC power into a combined power for the first system battery.

22. The system of claim 1, wherein:
the first charger module is configured to charge the first battery of the first battery set while the first battery is embedded at an electronic device.

23. The system of claim 22, wherein
the first charger module is configured to accommodate the electronic device while the first battery is charged.

24. The system of claim 1, further comprising:
an additional power generator to generate additional power for the input power; and
a power interface coupled to the power generator and to the additional power generator to merge the additional power into the input power for the charging station.

25. The system of claim 1, further comprising:
a network module coupled to the system controller and configured to access a communications network; and
a management application executable by a computer system and coupled to the system controller via the communications network;
wherein:
the management application is configured to receive real-time system information from the system controller; and
the system information comprises at least one of:
a number of charger modules coupled to the charging station;
a number of coupled batteries coupled to the charging station via the charger modules;
a battery type for one or more of the coupled batteries;
a charge status for the one or more of the coupled batteries;
a magnitude of the input power; or
a magnitude of the storage charge.

26. The system of claim 25, wherein:
the management application is configured to provide, based on the real-time system information, at least one of:
a real-time system summary display derived from the system information;
a software update for the charging station;
a subscription service for the charging station; or
an upgrade recommendation for the charging station.

27. The system of claim 26, further comprising:
additional charging stations coupled to the management application via the communications network;
wherein the management application is configured to aggregate the real-time system information with additional system information from the additional charging stations.

28. The system of claim 1, wherein:
the charging station is configured to prioritize charging of a priority battery selectable from the one or more rechargeable batteries when the priority battery is coupled to the charging station via at least one of the one or more receptacles or a power outlet of the charging station;
the system controller is configured to control transmission of a supplemental power to the priority battery when the priority battery is selected; and
the supplemental power is configured to be routed from other batteries of the one or more rechargeable batteries to supplement or substitute the output power from the first system battery.

29. The system of claim 1, wherein:
the system controller is configured to determine a battery chemistry of a target battery of the one or more rechargeable batteries based on a retained charge retained by the target battery after one or more charge/discharge cycles.

30. A method comprising:
providing a charging station to control a charging of one or more rechargeable batteries;
providing a power generator coupled to the charging station to generate an input power; and
providing a first charger module of one or more charger modules to couple to the charging station a first battery set of the one or more rechargeable batteries;
wherein:
providing the power generator comprises:
providing a solar power generator to convert a solar energy to a solar power for the input power;
providing the charging station comprises:
providing a first system battery to collect a storage charge derived from the input power;
providing one or more receptacles configured to couple the one or more charger modules to the charging station; and
providing a system controller to control an output power to each of the one or more receptacles based on charger module parameters received from the one or more charger modules;
the output power is sourced from the storage charge of the first system battery;
providing the first charger module comprises:
configuring the first charger module to interchangeably couple to the charging station via a first receptacle selectable from the one or more receptacles; and
providing a first battery charge controller set to:
couple with one or more batteries of the first battery set;
receive charging parameters from the system controller for each of the one or more batteries of the first battery set; and
variably charge each of the one or more batteries, based on the charging parameters from the system controller, with the output power received at the first receptacle; and
the charging parameters are generated by the system controller based on the charger module parameters from the first charger module.

31. The method of claim 30, wherein:
the charger module parameters comprise at least two of:
a battery type of the first battery set;
a battery quantity of the first battery set;
a battery temperature of each of the one or more of the batteries;
a battery charge of each of the one or more of the batteries; or
a battery chemistry of each of the one or more of the batteries; and
the charging parameters comprise, for each of the one or more batteries of the first battery set, at least one of:
a charging rate; or
a charge intensity.

32. The method of claim 30, wherein:
providing the first charger module comprises:
configuring the first charger module to interchangeably couple to two or more of the receptacles; and
providing a status display in real-time for each of the one or more first batteries, the status display comprising at least two of:
a low charge indicator;
a charging-in-progress indicator;
a full charge indicator; or
a battery malfunction indicator.

33. The method of claim 30, further comprising:
providing a second charger module to charge a second battery set of the one or more rechargeable batteries;
wherein:
providing the second charger module comprises:
configuring the second charger module to interchangeably couple to the charging station via either of:
the first receptacle; or
a second receptacle selectable from the one or more receptacles; and
providing the charging station comprises:
configuring the system controller to control the output power for each of the first and second charger modules.

34. The method of claim 30, wherein:
providing the first charger module comprises:
providing a first battery charge coupler to:
couple to a first battery of the first battery set;
periodically sense a charge status of the first battery; and
at least two of:
couple the first battery to the first battery charge controller to charge the first battery when the charge status comprises a partial charge status;
decouple the first battery from the first battery charge controller when the charge status comprises a full charge status; or
decouple the first battery from the first battery charge controller when the first status comprises a dysfunctional status.

35. The method of claim 30, wherein:
providing the power generator comprises:
providing a wind power generator to convert a wind energy to a wind power for the input power;
providing the charging station comprises:
providing a power management unit coupled to the power generator to:
combine the solar power and the wind power into the input power;
couple the input power from the power generator to the system battery; and
at least one of:
terminate an excess power of the input power; or
forward the excess power to a DC output coupler of the charging station.

36. The method of claim 30, further comprising:
providing a management application executable by a computer system and to communicate with the charging station via a communications network;
wherein:
providing the charging station comprises:
providing a network access mechanism coupled to the system controller and configured to access the communications network; and
providing the system controller comprises:
configuring the system controller to provide system information to the management application via the communications network;
providing the management application comprises:
configuring the management application to display summary information derived from the system information; and
the system information comprises at least one of:
a number of charger modules coupled to the charging station;
a number of coupled batteries coupled to the charging station via the charger modules;
a battery type for one or more of the coupled batteries
a charge status for the one or more of the coupled batteries;
a magnitude of the input power; or
a magnitude of the storage charge.

37. The method of claim 36, wherein:
providing the management application comprises:
configuring the management application to:
receive additional system information from additional charging stations; and
aggregate the system information with the additional system information.

38. The method of claim 30, further comprising at least one of:
providing an additional charging station coupled to at least one of the power generator or the charging station;
providing a remote charging unit comprising remote receptacles to couple with additional charger modules for additional batteries of the one or more rechargeable batteries; or
providing an additional system battery coupled to the charging station and supplemental to the first system battery.

39. The method of claim 30, wherein:
providing the charging station comprises:
providing the charging station to prioritize charging of a priority battery selectable from the one or more rechargeable batteries when the priority battery is coupled to the charging station via at least one of the one or more receptacles or a power outlet of the charging station; and
providing the system controller comprises:
providing the system controller is configured to control transmission of a supplemental power to the priority battery when the priority battery is selected,
the supplemental power being routed from other batteries of the one or more rechargeable batteries to supplement or substitute the output power from the first system battery.

40. A method comprising:
providing a charging station;
coupling a solar power generator to the charging station;
collecting a storage charge at a system battery of the charging station, the storage charge derived from solar power received from the solar power generator;
coupling a first charger module of a plurality of charger modules to a first receptacle of one or more receptacles of the charging station;
coupling a first battery set to the first charger module;
receiving, at the charging station, charger module parameters from first charger module, the charger module parameters comprising at least two of:
a battery type of the first battery set;
a battery quantity of the first battery set;
a battery temperature of each battery of the first battery set; or
a battery chemistry of each battery of the first battery set; and
receiving, at the first charger module, charging parameters from the charging station for each battery of the first battery set;
wherein the plurality of charger modules are interchangeably connectable to the one or more receptacles for coupling to the charging station.
